(19) United States
(12) Patent Application Publication
(10) Pub. No.: US 2020/0319571 A1
(43) Pub. Date: Oct. 8, 2020

(54) ELECTROPHOTOGRAPHIC DEVELOPER, REPLENISHMENT DEVELOPER, IMAGE FORMING APPARATUS, PROCESS CARTRIDGE, AND IMAGE FORMING METHOD

(71) Applicants: Kento TAKEUCHI, Shizuoka (JP); Yutaka MAKIBE, Shizuoka (JP); Kenichi MASHIKO, Shizuoka (JP); Masato TAIKOJI, Shizuoka (JP); Kei NIWAYAMA, Shizuoka (JP)

(72) Inventors: Kento TAKEUCHI, Shizuoka (JP); Yutaka MAKIBE, Shizuoka (JP); Kenichi MASHIKO, Shizuoka (JP); Masato TAIKOJI, Shizuoka (JP); Kei NIWAYAMA, Shizuoka (JP)

(21) Appl. No.: 16/835,385

(22) Filed: Mar. 31, 2020

(30) Foreign Application Priority Data
Apr. 3, 2019 (JP) 2019-071300

(51) Int. Cl. G03G 9/113; G03G 15/08; G03G 21/18; G03G 9/097; G03G 9/08

(52) U.S. Cl. CPC G03G 9/1132; G03G 15/08; G03G 9/0819; G03G 9/09708; G03G 21/1814

(57) ABSTRACT

An electrophotographic developer is provided. The electrophotographic developer comprises a toner and a carrier. The toner contains alumina particles. The carrier comprises a core particle and a resin layer coating a surface of the core particle. The carrier has a volume average particle diameter (Dv) of from 45 to 70 μm and a bulk density of from 2.1 to 2.5 g/cm³.

### CROSS-REFERENCE TO RELATED APPLICATIONS

This patent application is based on and claims priority pursuant to 35 U.S.C. § 119(a) to Japanese Patent Application No. 2019-071300, filed on Apr. 3, 2019, in the Japan Patent Office, the entire disclosure of which is hereby incorporated by reference herein.

### BACKGROUND

### Technical Field

The present disclosure relates to an electrophotographic developer, a replenishment developer, an image forming apparatus, a process cartridge, and an image forming method.

### Description of the Related Art

In an electrophotographic image forming process, an electrostatic latent image is formed on an electrostatic latent image bearer (e.g., photoconductive substance), and a charged toner is attached to the electrostatic latent image to form a toner image. The toner image is then transferred onto a recording medium and fixed thereon, thereby outputting an image. In recent years, with the increase in printing speed, a carrier has been strongly required to have an ability to quickly charge toner.

The charging ability of the conventional carrier has been insufficient for triboelectrically charging the toner supplied to the developer. Therefore, an undesirable phenomenon called “toner scattering” in which toner gets deposited outside the developing device or that called “background fouling” in which toner gets developed on the background portion has been occurring.

It is more demanded than ever to control the charge amount of the toner to be constant, but the conventional carrier is not able to respond to this demand.

### SUMMARY

In accordance with some embodiments of the present invention, an electrophotographic developer is provided. The electrophotographic developer comprises a toner and a carrier. The toner contains alumina particles. The carrier comprises a core particle and a resin layer coating a surface of the core particle. The carrier has a volume average particle diameter (Dv) of from 45 to 70 μm and a bulk density of from 2.1 to 2.5 g/cm³.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a process cartridge according to an embodiment of the present invention; and

FIGS. 2A and 2B are diagrams illustrating a normal image and a ghost image, respectively, of a vertical band chart.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

In attempting to improve image quality by preventing generation of a fogged image with time, a toner containing surface-treated metal oxide particles as external additives has been proposed.

Various attempts have been made to solve the above-described problem by improving durability of the carrier. For example, a method of coating carrier particles with an appropriate resin material has been proposed. Further, various methods of adding various additives to the resin layer have been proposed.

In a developer using a toner containing alumina particles as additives, a resin layer coating the surface of a carrier gets scraped due to collision between the alumina particles and the carrier during a long-term printing operation. As a result, the charge is increased with time, causing carrier deposition and insufficient image density.

In a developer using a toner containing a large amount of highly-abrading additives such as alumina particles, carrier particles are not prevented from being abraded even when the carrier particles are coated with a resin. Addition of an additive to the resin layer of the carrier increases durability of the carrier, but also affects the charging ability of the carrier at the time of printing. A combination of such a carrier with a toner containing alumina particles causes undesired phenomena such as an increase in charge after a long-term printing operation, non-transferring of toner to the developing unit, and insufficient image density.

According to some embodiments of the present invention, a developer having excellent charge stability that forms an image with a high image density for an extended period of time is provided.

Hereinafter, the present invention is described in detail.

### Developer

A developer according to an embodiment of the present invention comprises: a toner containing alumina particles; and a carrier comprising a core particle and a resin layer coating a surface of the core particle. The carrier has a volume average particle diameter (Dv) of from 45 to 70 μm and a bulk density of from 2.1 to 2.5 g/cm³.

Alumina particles are used as an external additive for the toner. However, since the alumina particles have high abrading property, the carrier gets scraped due to collision between the alumina particles and the carrier in a long-term printing operation, increasing the charge over time. In the present disclosure, the carrier having a volume average particle diameter (Dv) of from 45 to 70 μm and a bulk density of from 2.1 to 2.5 g/cm³ provides stable charging for an extended period of time.

In such a developer combining a toner containing alumina particles with a carrier, the carrier is imparted with excellent charging performance from the initial stage to the end of a long-term printing operation by the following two requirements of the present invention.

The first requirement is that the volume average particle diameter (Dv) of the carrier is from 45 to 70 μm. During a long-term printing operation, resins, waxes, additives, and the like of the toner get adhered to the surface of the resin layer of the carrier. Since these adhered materials have higher resistance than the resin of the resin layer of the carrier, the carrier resistance is increased with time. An increase of carrier resistance causes carrier deposition at edge portions, resulting in the occurrence of abnormal images such as white voids. It has been found that the occurrence of carrier deposition at edge portions with time is prevented when the volume average particle diameter of the carrier is 45 μm or more. When the volume average particle diameter of the carrier exceeds 70 μm, reproducibility of image details is so reduced that a fine image may not be formed, and a ghost image may be developed. Therefore, the volume average particle diameter of the carrier is adjusted to be in the range of from 45 to 70 μm.

The volume average particle diameter (Dv) of the carrier can be measured by, for example, a particle size distribution analyzer MICROTRAC Model HRA9320-X100 (manufactured by Nikkiso Co., Ltd.). The volume average particle diameter (Dv) is calculated based on a particle size distribution of particles measured on a volume basis and is represented by the following formula.

Dv={Σ(Vi×di)}×{Σ(Vi)}

In the formula, di represents a representative particle diameter (μm) of particles present in each channel, and Vi represents the volume of the particles present in each channel. Each channel represents a length for equally dividing the particle size range in the particle size distribution chart. In the present disclosure, the length is 2 μm. In the present disclosure, the representative particle diameter of particles present in each channel is the smallest particle size in that channel.

The second requirement is that the bulk density of the carrier is from 2.1 to 2.5 g/cm³. More preferably, the bulk density is from 2.35 to 2.5 g/cm³. When the bulk density of the carrier is less than 2.1 g/cm³, even if the magnetization (emu/g) in 1 KOe is large, the substantial magnetization per particle is small, which is disadvantageous for carrier deposition. When the bulk density of the carrier exceeds 2.5 g/cm³, it is likely that toner adheres to the carrier or the resin layer is peeled off due to collision between the carriers, degrading charging stability over time.

In the developer according to an embodiment of the present invention, adhesion of toner to the carrier is prevented, and peeling of the resin layer of the carrier due to collision between the alumina particles and the carriers is also prevented. Thus, the charge of the carrier is maintained at a desired level during a long-term printing operation.

The bulk density of the carrier can be measured by a conventionally known method. For example, according to a method described in JIS (Japanese Industrial Standards) Z-2504 (Metallic powders-Determination of apparent density), the carrier is made to naturally flow out from an orifice having a diameter of 2.5 mm into a 25-cm³ stainless steel cylindrical container put immediately below the orifice until the carrier overflows. After that, the upper surface of the container is scraped with a flat spatula made of a non-magnetic material along the upper edge of the container in a single operation.

In a case in which the carrier has a difficulty in flowing out from an orifice having a diameter of 2.5 mm, the carrier is made to naturally flow from an orifice having a diameter of 5 mm. The mass of the carrier per 1 cm³ is determined by dividing the mass of the carrier flowing into the container through this operation by the volume 25 cm³ of the container, and is defined as the bulk density of the carrier.

### Inorganic Particles

In the present disclosure, the resin layer of the carrier may contain inorganic particles. The inorganic particles become exposed during a long-term printing operation and exert a spacer effect, which drastically prevents abrasion and peeling of the resin layer caused by the stress due to stirring.

The material of the inorganic particles is not particularly limited. When the carrier is used in combination with a negatively-chargeable toner, the inorganic particles are preferably made of a positively-chargeable material, so that a charge imparting ability can be reliably provided for an extended period of time. Particularly preferred materials include barium sulfate, zinc oxide, magnesium oxide, magnesium hydroxide, and hydrotalcite. In particular, barium sulfate is preferred for its high ability for charging the negatively-chargeable toner and its white color that exerts little influence on the color of the toner even when it is detached from the coating resin.

### Carrier Coating Resin

Examples of the carrier coating resin include a silicone resin, an acrylic resin, and a combination thereof. Acrylic resins have high adhesiveness and low brittleness and thereby exhibit superior wear resistance. At the same time, acrylic resins have a high surface energy. Therefore, when used in combination with a toner which easily cause adhesion, the adhered toner components may be accumulated on the acrylic resin to cause a decrease of the amount of charge. This problem can be solved by using a silicone resin in combination with the acrylic resin. This is because silicone resins have a low surface energy and therefore the toner components are less likely to adhere thereto, which prevents accumulation of the adhered toner components that causes detachment of the coating film. At the same time, silicone resins have low adhesiveness and high brittleness and thereby exhibit poor wear resistance. Thus, it is preferable that these two types or resins be used in a good balance to provide a coating layer having wear resistance to which toner is difficult to adhere. This is because silicone resins have a low surface energy and the toner components are less likely to adhere thereto, which prevents accumulation of the adhered toner components that causes detachment of the coating film.

In the present disclosure, silicone resins refer to all known silicone resins. Examples thereof include, but are not limited to, straight silicone resins consisting of organosiloxane bonds, and modified silicone resins (e.g., alkyd-modified, polyester-modified, epoxy-modified, acrylic-modified, and urethane-modified silicone resins). Specific examples of commercially-available products of the straight silicone resins include, but are not limited to, KR271, KR255, and KR152 (available from Shin-Etsu Chemical Co., Ltd.); and SR2400, SR2406, and SR2410 (available from Dow Corning Toray Co., Ltd.). Each of these silicone resins may be used alone or in combination with a cross-linkable component and/or a charge amount controlling agent. Specific examples of the modified silicone resins include, but are not limited to, commercially-available products such as KR206 (alkyd-modified), KR5208 (acrylic-modified), ES1001N (epoxy-modified), and KR305 (urethane-modified) (available from Shin-Etsu Chemical Co., Ltd.); and SR2115 (epoxy-modified) and SR2110 (alkyd-modified) (available from Dow Corning Toray Co., Ltd.).

The resin layer may be formed on the surface of the core particle by a method such as spray drying, dipping, and powder coating. In particular, a method using a fluidized bed coating device is effective for forming a uniform coating film.

In the present disclosure, preferably, the resin layer composition contains a silane coupling agent, for reliable disperse of the inorganic particles in the resin layer.

Specific examples of the silane coupling agent include, but are not limited to, γ-(2-aminoethyl)aminopropyl trimethoxysilane, γ-(2-aminoethyl)aminopropylmethyl dimethoxysilane, γ-methacryloxypropyl trimethoxysilane, N-β-(N-vinylbenzylaminoethyl)-γ-aminopropyl trimethoxysilane hydrochloride, γ-glycidoxypropyl trimethoxysilane, γ-mercaptopropyl trimethoxysilane, methyl trimethoxysilane, methyl triethoxysilane, vinyl triacetoxysilane, 7-chloropropyl trimethoxysilane, hexamethyldisilazane, γ-anilinopropyl trimethoxysilane, vinyl trimethoxysilane, octadecyldimethyl[3-(trimethoxysilyl)propyl]ammonium chloride, γ-chloropropylmethyl dimethoxysilane, methyl trichlorosilane, dimethyl dichlorosilane, trimethyl chlorosilane, allyl triethoxysilane, 3-aminopropylmethyl diethoxysilane, 3-aminopropyl trimethoxysilane, dimethyl diethoxysilane, 1,3-divinyltetramethyl disilazane, and methacryloxyethyldimethyl(3-trimethoxysilylpropyl)ammonium chloride. Two or more of these materials can be used in combination.

Specific examples of commercially-available products of the silane coupling agents include, but are not limited to, AY43-059, SR6020, SZ6023, SH6026, SZ6032, SZ6050, AY43-310M, SZ6030, SH6040, AY43-026, AY43-031, sh6062, Z-6911, sz6300, sz6075, sz6079, sz6083, sz6070, sz6072, Z-6721, AY43-004, Z-6187, AY43-021, AY43-043, AY43-040, AY43-047, Z-6265, AY43-204M, AY43-048, Z-6403, AY43-206M, AY43-206E, Z6341, AY43-210MC, AY43-083, AY43-101, AY43-013, AY43-158E, Z-6920, and Z-6940 (available from Dow Corning Toray Co., Ltd.).

Preferably, the proportion of the silane coupling agent to the silicone resin is from 0.1% to 10% by mass. When the proportion of the silane coupling agent is less than 0.1% by mass, adhesion strength between the core particle/conductive particle and the silicone resin may be reduced to cause detachment of the resin layer during a long-term printing operation. When the proportion exceeds 10% by mass, toner filming may occur in a long-term printing operation.

The binder resin of the toner can be obtained by polymerization of raw material monomers.

A polycondensation catalyst is used to produce a polyester resin by polymerization.

Examples of the polycondensation catalysts include titanium-based catalysts, tin-based catalysts, zirconium-based catalysts, and aluminum-based catalysts. Among these catalysts, titanium-based catalysts are preferred for their excellent effects, and titanium diisopropoxybis(ethylacetoacetate) is most preferred. The reason for this is considered that this catalyst effectively accelerates condensation of silanol groups and is hardly to be deactivated.

### Core Material of Carrier

In the present disclosure, the core particle is not particularly limited as long as it is a magnetic material. Specific examples thereof include, but are not limited to: ferromagnetic metals such as iron and cobalt; iron oxides such as magnetite, hematite, and ferrite; various alloys and compounds; and resin particles in which these magnetic materials are dispersed. Among these materials, Mn ferrite, Mn—Mg ferrite, and Mn—Mg—Sr ferrite are preferred because they are environmentally-friendly. In the present disclosure, the volume average particle diameter of the carrier is adjusted to be in the range of from 45 to 70 μm. Since the volume average particle diameter of the carrier almost depends on the volume average particle diameter of the core particle, a core particle having a particle diameter of from 45 to 70 μm is suitably used.

### Toner

The toner according to an embodiment of the present invention contains alumina particles. Preferably, the alumina particles comprise fluorine-containing alumina. Such a toner exhibits good environmental stability in charge because the difference between a triboelectric charge amount under high temperature and high humidity and that under low temperature and low humidity is small. Conventionally, fluorine-containing alumina has been used as an external additive for toner.

In the present disclosure, the relation between the amount of aluminum in the alumina particles and the amount of fluorine used for surface treatment of the alumina particles, as well as the presence state of aluminum and fluorine in the toner, are appropriately adjusted. It has been found that the amounts of aluminum and fluorine in the surface layer of the alumina particles in the toner, particularly the amounts of aluminum and fluorine in the surface layer of the alumina particles present in a region extending from the outermost surface layer of the toner to a depth of about 5 nm, exerts a great influence on charge rising property. Here, the charge rising property is an ability of the toner to be charged in a short time upon friction with a carrier, especially a carrier whose charging ability has deteriorated with time.

In the present disclosure, the following formulae (1) and (2) are satisfied, where X1 and X2 represent a concentration of aluminum and a concentration of fluorine in the toner, respectively, determined by X-ray photoelectron spectroscopy (XPS).

2.7≤X1/X2≤5.5 Formula (1)

2.1≤X1≤3.0 Formula (2)

Referring to the formula (2), when X1 (concentration of aluminum) is smaller than 2.1, the saturated charge amount of the toner in a low-temperature low-humidity environment becomes too high, which causes a problem in quality such as a low image density.

When X1 is larger than 3.0, fluorine derived from the alumina particles gets adhered to the carrier with time to reduce the charging ability of the carrier. As a result, the toner deteriorates in charge rising property in a low-temperature low-humidity environment, the number of weakly-charged or reversely-charged toner particles increases, and a fogged image is likely to occur.

Referring to the formula (1), when the ratio X1/X2 of the concentration X1 of aluminum to the concentration X2 of fluorine is smaller than 2.7, fluorine derived from the alumina particles gets adhered to the carrier with time to reduce the charging ability of the carrier. As a result, the toner deteriorates in charge rising property in a low-temperature low-humidity environment, the number of weakly-charged or reversely-charged toner particles increases, and a fogged image occurs. When X1/X2 is larger than 5.5, the amount of fluorine contributing to charge rising of the toner is too small. As a result, the toner deteriorates in charge rising property in a low-temperature low-humidity environment, the number of weakly-charged or reversely-charged toner particles increases, and a fogged image occurs.

It is more preferable that X1 and X1/X2 further satisfy the following formulae (3) and (4). When the formulae (3) and (4) are satisfied, image quality problems such as the occurrence of fogged images, particularly caused over time due to insufficient charge rising upon friction between the toner and the carrier in the image forming apparatus, are solved.

2.8≤X1/X2≤5.2 Formula (3)

2.1≤X1≤2.9 Formula (4)

The concentration X1 of aluminum and the concentration X2 of fluorine in the outermost surface layer of the toner are measured by X-ray photoelectron spectroscopy (XPS) under the following measurement conditions.

Analysis equipment: AXIS-ULTRA (manufactured by Shimadzu Corporation)

X-Ray: 15 kV, 9 mA, Hybrid

Neutralization gun: 2.0 A (F-Current), 1.3 V (F-Bias), 1.8 V (C-Balance)

Step: 0.1 eV (Narrow), 2.0 eV (Wide)

Pass E: 20 eV (Narrow), 160 eV (Wide)

Relative sensitivity coefficient: Use the relative sensitivity coefficient of Casa XPS

### Materials Contained in Toner

Next, materials contained in the toner are described in detail below. Inorganic Particles The toner may contain inorganic particles other than alumina particles in combination with the alumina particles. Specific examples of the other inorganic particles include, but are not limited to, silica, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The inorganic particles may be surface-treated to improve hydrophobicity thereof for preventing deterioration of fluidity and chargeability even under high-humidity conditions. Specific preferred examples of surface treatment agents include, but are not limited to, fluorine-containing silane coupling agents, silylation agents, silane coupling agents having a fluorinated alkyl group, organic titanate coupling agents, aluminum coupling agents, silicone oils, and modified silicone oils.

The amount of the inorganic particles to be added to 100 parts by mass of the toner particles is from 0.4 to 4.0 parts by mass, more preferably from 1.0 to 2.2 parts by mass. When the amount of addition is 0.4 parts by mass or more, fluidity and cohesiveness of the toner are sufficiently improved, preventing deterioration of half-tone image quality and the occurrence of white voids in the image which may caused due to toner aggregation. When the amount of addition is 4.0 parts by mass or less, the lower-limit fixable temperature is not increased and low-temperature fixability is not degraded. When the amount of addition is less than 0.4 parts by mass, the toner is able to neither ensure fluidity nor achieve an appropriate chargeability, resulting in an image with background fouling due to the occurrence of toner scattering. When the amount of addition is more than 4.0 parts by mass, the external additive is easily liberated from the toner base particles, which increases filming of the external additive.

### Wax

Preferably, the toner of the present disclosure contains at least one of carnauba wax, rice wax, and ester wax as a wax component.

Carnauba wax is a natural wax obtained from the leaves of carnauba palm. Those with a low acid value from which free fatty acids have been eliminated are preferred because they can be uniformly dispersed in the binder resin.

Rice wax is a natural wax obtained by purifying crude wax produced in a dewaxing or wintering process in purifying rice bran oil extracted from rice bran. An ester wax is synthesized by an esterification reaction between a monofunctional straight-chain fatty acid and a monofunctional straight-chain alcohol.

These wax components may be used alone or in combination with others. The amount of addition of the wax component in 100 parts by mass of the toner particles is from 0.5 to 20 parts by mass, more preferably from 2 to 10 parts by mass.

In the present disclosure, wax components other than carnauba wax, rice wax, and synthetic ester wax can also be used. Examples thereof include, but are not limited to, polyolefin waxes such as polypropylene wax and polyethylene wax.

### Binder Resin

Examples of the binder resin of the present disclosure include polymer resins obtained by a condensation polymerization reaction, such as polyester, polyamide, and polyester-polyamide resin, and polymer resins obtained by an addition polymerization reaction, such as styrene-acrylic and styrene-butadiene. The binder resin is not particularly limited as long as it is a polymer obtained by a condensation polymerization reaction or an addition polymerization reaction.

The polyester resin used in the present disclosure is a polymer obtained by a condensation polymerization between a polyhydroxy compound and a polybasic acid. Examples of the polyhydroxy compound include, but are not limited to: glycols such as ethylene glycol, diethylene glycol, triethylene glycol, and propylene glycol; alicyclic compounds having two hydroxyl groups, such as 1,4-bis(hydroxymethyl) cyclohexane; and divalent phenols such as bisphenol A. In addition, the polyhydroxy compound includes compounds having three or more hydroxyl groups.

Examples of the polybasic acid include, but are not limited to, divalent carboxylic acids such as maleic acid, fumaric acid, phthalic acid, isophthalic acid, terephthalic acid, succinic acid, and malonic acid, and trivalent or higher polyvalent carboxylic acid monomers such as 1,2,4-benzenetricarboxylic acid, 1,2,5-benzenetricarboxylic acid, 1,2,4-cyclohexanetricarboxylic acid, 1,2,4-naphthalenetricarboxylic acid, 1,2,5-hexanetricarboxylic acid, 1,3-dicarboxyl-2-methylenecarboxypropane, and 1,2,7,8-octanetetracarboxylic acid.

Examples of raw material monomers for polyester-polyamide and polyamide include, in addition to the above-described raw material monomers, monomers for forming amide components such as polyamines (e.g., ethylenediamine, pentamethylenediamine, hexamethylenediamine, phenylenediamine, triethylenetetramine) and aminocarboxylic acids (e.g., 6-aminocaproic acid, ε-caprolactam). The glass transition temperature Tg of the binder resin is preferably 55 degrees C. or higher, more preferably 57 degrees C. or higher, for heat resistance storage stability.

Examples of the polymer resin obtained by an addition polymerization reaction include, but are not limited to, vinyl resins obtained by a radical polymerization. Examples of raw material monomers for an addition polymerization resin include, but are not limited to, styrene, o-methylstyrene, m-methylstyrene, p-methylstyrene, α-methylstyrene, p-ethylstyrene, vinylnaphthalene; unsaturated monoolefins such as ethylene, propylene, butylene, and isobutylene; vinyl esters such as vinyl chloride, vinyl bromide, vinyl acetate, and vinyl formate; ethylenic monocarboxylic acids and esters thereof, such as acrylic acid, methyl acrylate, ethyl acrylate, n-propyl acrylate, isopropyl acrylate, tert-butyl acrylate, amyl acrylate, methacrylic acid, methyl methacrylate, ethyl methacrylate, n-propyl methacrylate, isopropyl methacrylate, tert-butyl methacrylate, amyl methacrylate, stearyl methacrylate, methoxyethyl methacrylate, glycidyl methacrylate, phenyl methacrylate, dimethylaminoethyl methacrylate, and diethylaminoethyl methacrylate; ethylenic monocarboxylic acid substituents such as acrylonitrile, methacrylonitrile, and acrylamide; ethylenic dicarboxylic acids and substituted products thereof such as dimethyl maleate; and vinyl ketones such as vinyl methyl ketone. A cross-linking agent may be further added, as needed. Examples of the cross-linking agent for addition polymerization monomers include, but are not limited to, general cross-linking agents such as divinylbenzene, divinylnaphthalene, polyethylene glycol dimethacrylate, diethylene glycol dimethacrylate, triethylene glycol diacrylate, dipropylene glycol dimethacrylate, polypropylene glycol dimethacrylate, and diallyl phthalate.

The amount of the cross-linking agent to be used for 100 parts by mass of raw material monomers for an addition polymerization resin is from 0.05 to 15 parts by mass, more preferably from 0.1 to 10 parts by mass. When the amount is less than 0.05 parts by mass, the cross-linking agent cannot exert its effect. When the amount exceeds 15 parts by mass, it is difficult for the toner to melt by heat, resulting in defective thermal fixation of the toner.

### Polymerization Initiator

The binder resin of the toner can be obtained by polymerization of raw material monomers. A polymerization initiator is used when polymerizing raw material monomers for an addition polymerization resin. Examples of the polymerization initiator include, but are not limited to: azo-based or diazo-based polymerization initiators such as 2,2′-azobis(2,4-dimethylvaleronitrile), 2,2′-azobisisobutyronitrile; and peroxide polymerization initiators such as benzoyl peroxide, methyl ethyl ketone peroxide, and 2,4-dichlorobenzoyl peroxide. These polymerization initiators may be used in combination for the purpose of controlling the molecular weight and molecular weight distribution of the polymer. The amount of the polymerization initiator to be used for 100 parts by mass of raw material monomers for an addition polymerization resin is from 0.05 to 15 parts by mass, more preferably from 0.5 to 10 parts by mass.

Depending on the types of raw materials used, the condensation polymerization reaction or addition polymerization reaction produces either a polymer having a non-linear structure or a polymer having a linear structure. In the present disclosure, both a non-linear polymer resin (A) and a linear polymer resin (B) are used.

In the present disclosure, the non-linear polymer resin refers a polymer resin having a substantial cross-linked structure, and the linear polymer resin refers to a polymer resin substantially having no cross-linked structure.

In the present disclosure, preferably, a hybrid resin in which a condensation polymerization resin and an addition polymerization resin are chemically bonded is obtained by polymerizing monomers for the both resins using a compound (hereinafter “bireactive monomer”) reactive with the both resins. Examples of such a bireactive monomer include, but are not limited to, compounds such as fumaric acid, acrylic acid, methacrylic acid, maleic acid, and dimethyl fumarate.

The amount of the bireactive monomer to be used for 100 parts by mass of raw material monomers for an addition polymerization resin is from 1 to 25 parts by mass, more preferably from 2 to 10 parts by mass. When the amount is less than 1 part by mass, a colorant and a charge controlling agent are poorly dispersed in the toner, causing deterioration of image quality such as the occurrence of fogged image. When the amount is more than 25 parts by mass, gelation of the resin undesirably occurs.

In preparation of the hybrid resin, the both reactions need not simultaneously progress or complete, and may independently progress or complete by selecting respective reaction temperatures and times. For example, the hybrid resin may be prepared by as follows. A mixture of condensation-polymerizing raw material monomers for a polyester resin is put in a reaction vessel, then another mixture of addition-polymerizing raw material monomers for a vinyl resin and a polymerization initiator is dropped therein, and they are mixed in advance. After that, first, a radical polymerization reaction of the addition-polymerizing raw material monomers for a vinyl resin is completed, and next, the reaction temperature is raised to complete a condensation polymerization reaction of the condensation-polymerizing raw material monomers for a polyester resin. In this method, two reactions independently proceed in the reaction vessel, thereby effectively dispersing two types of resins.

In the present disclosure, a resin other than the resins described above may be used in combination as a resin component in the toner as long as the performance of the toner is not impaired. Examples of usable resins include, but are not limited to, polyurethane resin, silicone resin, ketone resin, petroleum resin, and hydrogenated petroleum resin. Each of these resins may be used alone or in combination with others.

### Other Components

Other components contained in the toner are not particularly limited and can be suitably selected to suit to a particular application. Examples thereof include, but are not limited to, a colorant, a charge controlling agent, a fluidity improving agent, a cleanability improving agent, and a magnetic material.

### Colorant

The colorant is not particularly limited and can be suitably selected to suit to a particular application. Examples thereof include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone.

The amount of the colorant in the toner is not particularly limited and can be suitably selected to suit to a particular application. Preferably, the amount of the colorant in 100 parts by mass of the toner is from 1 to 15 parts by mass, more preferably from 3 to 10 parts by mass.

The colorant can be combined with a resin to be used as a master batch. Examples of the resin to be used for manufacturing or the master batch or kneaded with the master batch include, but are not limited to: amorphous polyester resins; polymers of styrene or substitutes thereof, such as polystyrene, poly p-chlorostyrene, and polyvinyl toluene; styrene-based copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleate copolymer; and polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, and paraffin wax. Each of these can be used alone or in combination with others.

The master batch can be obtained by mixing and kneading the resin and the colorant while applying a high shearing force thereto. To increase the interaction between the colorant and the resin, an organic solvent may be used. More specifically, the maser batch can be obtained by a method called flushing in which an aqueous paste of the colorant is mixed and kneaded with the resin and the organic solvent so that the colorant is transferred to the resin side, followed by removal of the organic solvent and moisture. This method is advantageous in that the resulting wet cake of the colorant can be used as it is without being dried. Preferably, the mixing and kneading is performed by a high shearing dispersing device such as a three roll mill.

### Charge Controlling Agent

The charge controlling agent is not particularly limited and can be suitably selected to suit to a particular application. Examples thereof include, but are not limited to, nigrosine dyes, triphenylmethane dyes, chromium-containing metal complex dyes, chelate pigments of molybdic acid, Rhodamine dyes, alkoxyamines, quaternary ammonium salts (including fluorine-modified quaternary ammonium salts), alkylamides, phosphorus and phosphorus-containing compounds, tungsten and tungsten-containing compounds, fluorine activators, metal salts of salicylic acid, and metal salts of salicylic acid derivatives.

Specific examples of commercially-available charge controlling agents include, but are not limited to, BONTRON 03 (nigrosine dye), BONTRON P-51 (quaternary ammonium salt), BONTRON S-34 (metal-containing azo dye), BONTRON E-82 (metal complex of oxynaphthoic acid), BONTRON E-84 (metal complex of salicylic acid), and BONTRON E-89 (phenolic condensation product), available from Orient Chemical Industries Co., Ltd.; TP-302 and TP-415 (molybdenum complexes of quaternary ammonium salts), available from Hodogaya Chemical Co., Ltd.; LRA-901, and LR-147 (boron complex), available from Japan Carlit Co., Ltd.; and cooper phthalocyanine, perylene, quinacridone, azo pigments, and polymers having a functional group such as a sulfonic acid group, a carboxyl group, and a quaternary ammonium group.

The amount of the charge controlling agent in the toner is not particularly limited and can be suitably selected to suit to a particular application. Preferably, the amount of the charge controlling agent in 100 parts by mass of the toner is from 0.1 to 10 parts by mass, more preferably from 0.2 to 5 parts by mass. When the amount is 10 parts by mass or less, chargeability of the toner is appropriate, the effect of the charge controlling agent is well exerted, the electrostatic attractive force to a developing roller is appropriate, and the fluidity of the developer is good, leading to a high image density. The charge controlling agent may be melt-kneaded with the master batch or the binder resin and thereafter dissolved or dispersed in an organic solvent, or directly dissolved or dispersed in an organic solvent. Alternatively, the charge controlling agent may be fixed on the surface of the resulting toner particles.

### Fluidity Improving Agent

The fluidity improving agent is not particularly limited and can be suitably selected to suit to a particular application as long as it reforms a surface to improve hydrophobicity for preventing deterioration of fluidity and chargeability even under high-humidity environments. Specific examples thereof include, but are not limited to, silane coupling agents, silylation agents, silane coupling agents having a fluorinated alkyl group, organic titanate coupling agents, aluminum coupling agents, silicone oils, and modified silicone oils. Preferably, the above-described silica and titanium oxide are surface-treated with such a fluidity improving agent to become hydrophobic silica and hydrophobic titanium oxide, respectively.

### Cleanability Improving Agent

The cleanability improving agent is not particularly limited and can be suitably selected to suit to a particular application as long as it is added to the toner for facilitating removal of the developer remaining on a photoconductor or primary transfer medium after image transfer. Specific examples thereof include, but are not limited to, metal salts of fatty acids (e.g., zinc stearate, calcium stearate) and polymer particles prepared by soap-free emulsion polymerization (e.g., polymethyl methacrylate particles, polystyrene particles). Preferably, the particle size distribution of the polymer particles is relatively narrow, and the volume average particle diameter thereof is preferably from 0.01 to 1 μm.

### Toner Production Method

The toner production method of the present disclosure may be a conventionally known method, in which a resin component, a colorant, and a wax component, optionally along with a charge controlling agent, are mixed using a mixer, kneaded with a kneader such as a heat roll and an extruder, cooled for solidification, pulverized with a pulverizer such as a jet mill, and then classified.

The production method is not particularly limited to the above, and any of bulk polymerization, solution polymerization, emulsion polymerization, and suspension polymerization can be employed.

### Replenishment Developer

The carrier according to an embodiment of the present invention can be combined with a toner to be used as a replenishment developer. This replenishment developer is used for an image forming apparatus which forms an image while discharging surplus developer in the developing device, for reliably providing high image quality for an extremely extended period of time. This is because the deteriorated carrier particles in the developing device are replaced with non-deteriorated carrier particles contained in the replenishment developer. Thus, the amount of charge is kept constant and images are reliably produced for an extended period of time. Such a system is particularly advantageous for printing an image with a high image area occupancy. When printing an image having a high image area occupancy, generally, the charge of the carrier particles gets deteriorated as toner particles get adhered to the carrier particles. By contrast, in the above system, a large amount of carrier particles is supplied when printing an image having a high image area occupancy, and deteriorated carrier particles can be more frequently replaced with non-deteriorated carrier particles. Accordingly, high image quality is reliably provided for an extremely extended period of time.

Preferably, the replenishment developer contains 2 to 50 parts by mass of the toner with respect to 1 part by mass of the carrier. When the amount of the toner is less than 2 parts by mass, the amount of the supplied carrier is so large that the carrier concentration in the developing device becomes too high. Therefore, the amount of charge of the developer is likely to increase. As the amount of charge of the developer increases, the developing ability deteriorates, and the image density lowers. When the amount of the toner exceeds 50 parts by mass, the proportion of the carrier in the replenishment developer is so small that replacement of the carrier particles becomes less frequent in the image forming apparatus, with which no effect on deterioration of carrier can be expected.

### Image Forming Method

An image forming method according to an embodiment of the present invention includes the processes of: forming an electrostatic latent image on an electrostatic latent image bearer; developing the electrostatic latent image formed on the electrostatic latent image bearer using the developer according to an embodiment of the present invention to form a toner image; transferring the toner image formed on the electrostatic latent image bearer onto a recording medium; and fixing the toner image on the recording medium.

Process Cartridge

A process cartridge according to an embodiment of the present invention includes: an electrostatic latent image bearer; a charger configured to charge a surface of the electrostatic latent image bearer; a developing device containing the developer according to an embodiment of the present invention, configured to develop an electrostatic latent image formed on the electrostatic latent image bearer using the developer to form a toner image; and a cleaner configured to clean the electrostatic latent image bearer.

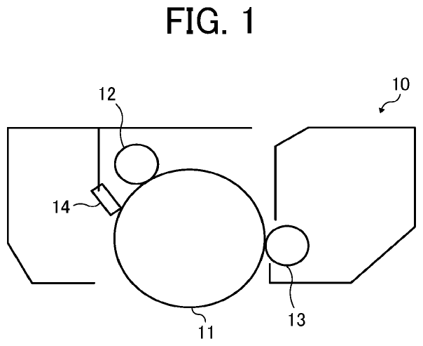

FIG. 1 is a schematic diagram illustrating a process cartridge according to an embodiment of the present invention. A process cartridge 10 includes: a photoconductor 11; a charger 12 configured to charge the photoconductor 11; a developing device 13 containing the developer according to an embodiment of the present invention, configured to develop the electrostatic latent image formed on the photoconductor 11 using the developer to form a toner image; and a cleaner 14 configured to remove residual toner remaining on the photoconductor 11 after the toner image formed on the photoconductor 11 has been transferred onto a recording medium. The process cartridge 10 is detachably mountable on an image forming apparatus such as a copier and a printer.

An image forming apparatus on which the process cartridge 10 is mounted forms an image in the following manner. First, the photoconductor 11 is driven to rotate at a certain peripheral speed. The circumferential surface of the photoconductor 11 is uniformly charged to a certain positive or negative potential by the charger 12. The charged circumferential surface of the photoconductor 11 is irradiated with exposure light emitted from an exposure device (e.g., slit exposure device, laser beam scanning exposure device), and an electrostatic latent image is formed thereon. The electrostatic latent image formed on the circumferential surface of the photoconductor 11 is developed using the developer according to an embodiment of the present invention by the developing device 13 to form a toner image. The toner image formed on the circumferential surface of the photoconductor 11 is transferred onto a transfer sheet that is fed from a sheet feeder to between the photoconductor 11 and a transfer device in synchronization with rotation of the photoconductor 11. The transfer sheet having the transferred toner image thereon is separated from the circumferential surface of the photoconductor 11 and introduced into a fixing device. The toner image is fixed on the transfer sheet in the fixing device and then output as a copy from the image forming apparatus. On the other hand, after the toner image has been transferred, the surface of the photoconductor 11 is cleaned by removing residual toner by the cleaner 14 and then neutralized by a neutralizer, so that the photoconductor 11 gets ready for a next image forming operation.

### Image Forming Apparatus

An image forming apparatus according to an embodiment of the present invention includes: an electrostatic latent image bearer; a charger configured to charge the electrostatic latent image bearer; an irradiator configured to form an electrostatic latent image on the electrostatic latent image bearer; a developing device containing the developer according to an embodiment of the present invention, configured to develop the electrostatic latent image formed on the electrostatic latent image bearer using the electrophotographic developer to form a toner image; a transfer device configured to transfer the toner image formed on the electrostatic latent image bearer onto a recording medium; and a fixing device configured to fix the toner image on the recording medium. The image forming apparatus may further include other devices such as a neutralizer, a cleaner, a recycler, and a controller, as needed.

### EXAMPLES

Having generally described this invention, further understanding can be obtained by reference to certain specific examples which are provided herein for the purpose of illustration only and are not intended to be limiting. In the following descriptions, “parts” and “%” represent “parts by mass” and “% by mass”, respectively.

### Production of Binder Resins

First, production examples of binder resins are described in detail.

### Production of Non-Linear Polyester Resin

In a flask equipped with a stainless steel stirring rod, a flow-down condenser, a nitrogen gas inlet tube, and a thermometer, 9.0 mol of fumaric acid, 3.5 mol of trimellitic anhydride, 5.5 mol of bisphenol A (2,2) propylene oxide, 3.5 mol of bisphenol A (2,2) ethylene oxide were stirred and subjected to a condensation polymerization reaction under a nitrogen atmosphere at 230 degrees C. Thus, a non-linear polyester resin (A) was prepared.

The non-linear polyester resin (A) had a softening point (Tm) of 145.1 degrees C., a glass transition temperature (Tg) of 61.5 degrees C., and a weight average molecular weight (Mw) of 82,000.

### Production of Linear Polyester Resin

In a flask equipped with a stainless steel stirring rod, a flow-down condenser, a nitrogen gas inlet tube, and a thermometer, 7 mol of terephthalic acid, 2.5 mol of trimellitic anhydride, 5.5 mol of bisphenol A (2,2) propylene oxide, 3.5 mol of bisphenol A (2,2) ethylene oxide were stirred and subjected to a condensation polymerization reaction under a nitrogen atmosphere at 230 degrees C. Thus, a linear polyester resin (B) was prepared.

The linear polyester resin (B) had a softening point (Tm) of 102.8 degrees C., a glass transition temperature (Tg) of 61.2 degrees C., and a weight average molecular weight (Mw) of 8,000.

### Production of Hybrid Resin

In a dropping funnel, 18 mol of styrene and 4.5 mol of butyl methacrylate as addition-polymerization reactive monomers, and 0.35 mol of t-butyl hydroperoxide as a polymerization initiator were put. In a flask equipped with a stainless steel stirring rod, a flow-down condenser, a nitrogen gas inlet tube, and a thermometer, 9.0 mol of fumaric acid as an addition-polymerization condensation-polymerization bireactive monomer, 3.5 mol of trimellitic anhydride, 5.5 mol of bisphenol A (2,2) propylene oxide, and 3.8 mol of bisphenol A (2,2) ethylene oxide as condensation-polymerization reactive monomers, and 58 mol of dibutyltin oxide as an esterification catalyst were stirred under a nitrogen atmosphere at 138 degrees C., and the mixture of addition-polymerization raw materials was dropped therein over a period of 4 hours. After that, an aging was performed for 6 hours while maintaining the temperature at 138 degrees C., then the temperature was raised to 230 degrees C. to conduct a reaction. Thus, a hybrid resin (C) was prepared.

The hybrid resin (C) had a softening point (Tm) of 151.5 degrees C. and a glass transition temperature (Tg) of 62.1 degrees C.

### Production of Alumina Particles

### Alumina Particles Production Example 1

Alumina having a BET specific surface area of 120 m²/g was put in a reaction vessel, and a mixed solution of 8 g of heptadecafluorodecyltrimethoxysilane and 1.8 g of hexamethyldisilazane was sprayed on 100 g of alumina particles under stirring in a nitrogen atmosphere. The alumina particles were heat-stirred at 220 degrees C. for 150 minutes and then cooled. Thus, fluorine-containing alumina particles 1 were prepared.

### Alumina Particles Production Example 2

Alumina having a BET specific surface area of 120 m²/g was put in a reaction vessel, and a mixed solution of 4 g of heptadecafluorodecyltrimethoxysilane and 0.5 g of hexamethyldisilazane was sprayed on 100 g of alumina particles under stirring in a nitrogen atmosphere. The alumina particles were heat-stirred at 220 degrees C. for 150 minutes and then cooled. Thus, fluorine-containing alumina particles 2 were prepared.

### Production of Toners

### Toner Production Example 1

Non-linear polyester resin (A): 42 parts
Linear polyester resin (B): 45 parts
Hybrid resin (C) (Polyester (Mw: 48,000)/Styrene-acrylic (Mw: 190,000)=78/22): 13 parts
Carbon black colorant: 18 parts
Charge controlling agent (SPILON BLACK TR-H manufactured by Hodogaya Chemical Co., Ltd.): 2.5 parts
Low-molecular-weight polypropylene (having a weight average molecular weight of 5500): 2.5 parts

The above materials were stirred and mixed using a HENSCHEL MIXER. The mixture was heat-melted using a roll mill at a temperature of from 125 to 130 degrees C. for about 40 minutes, then cooled to room temperature. The resulted kneaded product was pulverized and classified using a jet mill. Thus, toner base particles A were prepared having a volume average particle diameter of 7.0 μm and a particle diameter distribution in which the proportion of particles having a particle diameter of 5 μm or less was 35% by number.

Next, the toner base particles A were mixed with external additives according to the following formulation.
Toner base particles A: 100 parts
Silica particles (R-972 manufactured by Nippon Aerosil Co., Ltd.): 1.2 parts
Fluorine-containing alumina particles 1: 0.4 parts

The external additives were stirred and mixed using a HENSCHEL MIXER under the following external additive mixing conditions, then large particles were removed through a mesh. Thus, a toner A was prepared.

Frequency: 80 HZ

Time: 10 min

### Toner Production Example 2

A toner B was prepared in the same manner as in Toner Production Example 1 except that the additive formulation and the external additive mixing conditions in the HENSCHEL MIXER were changed as follows.

Additive formulation (based on 100 parts of toner base particles):
Toner base particles A: 100 parts
Silica particles (R-972 manufactured by Nippon Aerosil Co., Ltd.): 1.2 parts
Fluorine-containing alumina particles 2: 1.0 part

External additive mixing conditions:

Frequency: 90 HZ

Time: 15 min

### Toner Production Example 3

A toner C was prepared in the same manner as in Toner Production Example 1 except that the additive formulation and the external additive mixing conditions in the HENSCHEL MIXER were changed as follows.
Toner base particles A: 100 parts
Silica particles (R-972 manufactured by Nippon Aerosil Co., Ltd.): 1.2 parts
Fluorine-containing alumina particles 1: 1.0 part

External additive mixing conditions:

Frequency: 90 HZ

Time: 15 min

### Production of Carriers

### Carrier Production Example 1

### Production of Resin Liquid 1

Silicone resin solution (having a solid content concentration of 40%): 2,100 parts
Aminosilane (having a solid content concentration of 100%): 30 parts
Toluene: 6,100 parts

The above materials were subjected to a dispersion treatment using a HOMOMIXER for 10 minutes, thus obtaining a resin liquid 1 for forming a resin layer.

Production of Carrier Coated with Resin Layer

Core particles 1 (Cu—Zn ferrite having a Dv of 55 μm and an apparent density of 2.58 g/cm³) were coated with the resin liquid 1 by a SPIRA COTA (manufactured by Okada Seiko Co., Ltd.) at a rate of 30 g/min in an atmosphere having a temperature of 60 degrees C., followed by drying, to forma coating layer having a thickness of 0.50 μm. The core particles having the coating layer thereon was burnt in an electric furnace at 230 degrees C. for 1 hour, then cooled, and pulverized with a sieve having an opening of 100 μm. Thus, a carrier 1 was prepared. The average thickness T was 0.50 μm. As a result of back calculation from the above-described formulation, the total amount of particles contained in 100 parts by mass of the carrier coating resin was 238 parts by mass.

The volume average particle diameter of the core particles was measured by a particle size analyzer MICROTRAC SRA (manufactured by Nikkiso Co., Ltd.) while setting the measuring range to from 0.7 μm to 125 μm.

The thickness T (μm) that is the average distance between the surface of the core particle and the surface of the resin layer was determined by observing a cross-section of the carrier particle with a transmission electron microscope (TEM), measuring the distance between the surface of the core particle and the surface of the resin layer at 50 points along the surface of the carrier particle at intervals of 0.2 μm, and averaging the measured values.

### Carrier Production Example 2

A carrier 2 was prepared in the same manner as in Carrier Production Example 1 except for replacing the core particles 1 with core particles 2 (Cu—Zn ferrite having a Dv of 50 μm and an apparent density of 2.61 g/cm³).

### Carrier Production Example 3

A carrier 3 was prepared in the same manner as in Carrier Production Example 1 except for replacing the core particles 1 with core particles 3 (Cu—Zn ferrite having a Dv of 66 μm and an apparent density of 2.55 g/cm³).

### Carrier Production Example 4

A carrier 4 was prepared in the same manner as in Carrier Production Example 1 except for replacing the core particles 1 with core particles 4 (Cu—Zn ferrite having a Dv of 56 μm and an apparent density of 2.30 g/cm³).

### Carrier Production Example 5

A carrier 5 was prepared in the same manner as in Carrier Production Example 1 except for replacing the core particles 1 with core particles 5 (Cu—Zn ferrite having a Dv of 53 μm and an apparent density of 2.65 g/cm³).

### Carrier Production Example 6

Resin Liquid 2
Silicone resin solution (having a solid content concentration of 40%): 2,100 parts
Aminosilane (having a solid content concentration of 100%): 30 parts
Barium sulfate (having an average particle diameter of 0.60 μm): 1,000 parts
Toluene: 6,100 parts

A carrier 6 was prepared in the same manner as in Carrier Production Example 1 except that the resin liquid 1 was replaced with the resin liquid 2.

### Carrier Production Example 7

Resin Liquid 3
Silicone resin solution (having a solid content concentration of 40%): 2,100 parts
Aminosilane (having a solid content concentration of 100%): 30 parts
Magnesium oxide (having an average particle diameter of 0.55 m): 1,000 parts
Toluene: 6,100 parts

A carrier 7 was prepared in the same manner as in Carrier Production Example 1 except that the resin liquid 1 was replaced with the resin liquid 3.

### Carrier Production Example 8

Resin Liquid 4
Silicone resin solution (having a solid content concentration of 40%): 2,100 parts
Aminosilane (having a solid content concentration of 100%): 30 parts
Hydrotalcite (having an average particle diameter of 0.58 m): 1,000 parts
Toluene: 6,100 parts

A carrier 8 was prepared in the same manner as in Carrier Production Example 1 except that the resin liquid 1 was replaced with the resin liquid 4.

### Carrier Production Example 9

A carrier 9 was prepared in the same manner as in Carrier Production Example 1 except for replacing the core particles 1 with core particles 6 (Cu—Zn ferrite having a D50 of 42 μm and an apparent density of 2.60 g/cm³).

### Carrier Production Example 10

A carrier 10 was prepared in the same manner as in Carrier Production Example 1 except for replacing the core particles 1 with core particles 7 (Cu—Zn ferrite having a Dv of 72 μm and an apparent density of 2.50 g/cm³).

### Carrier Production Example 11

A carrier 11 was prepared in the same manner as in Carrier Production Example 1 except for replacing the core particles 1 with core particles 8 (Cu—Zn ferrite having a Dv of 61 μm and an apparent density of 2.22 g/cm³).

### Carrier Production Example 12

A carrier 12 was prepared in the same manner as in Carrier Production Example 1 except for replacing the core particles 1 with core particles 9 (Cu—Zn ferrite having a Dv of 50 μm and an apparent density of 2.70 g/cm³).

The types of the core material and the types of the resin liquid used for the carriers 1 to 12 are presented in Table 1.

TABLE 1

| | Core Material of Carrier | | | | |
|---|---|---|---|---|---|
| | Core | Core | D50 of Core | Apparent | |
| | Material | Material | Material | Density | Resin Liquid |
| Carrier No. | No. | Composition | (μm) | (g/cm³) | No. |
| Carrier 1 | Core Particles 1 | Cu—Zn | 55 | 2.58 | Resin Liquid 1 |
| Carrier 2 | Core Particles 2 | Ferrite | 50 | 2.61 | Resin Liquid 1 |
| Carrier 3 | Core Particles 3 | | 66 | 2.55 | Resin Liquid 1 |
| Carrier 4 | Core Particles 4 | | 56 | 2.30 | Resin Liquid 1 |
| Carrier 5 | Core Particles 5 | | 53 | 2.65 | Resin Liquid 1 |
| Carrier 6 | Core Particles 1 | | 55 | 2.58 | Resin Liquid 2 |
| Carrier 7 | Core Particles 1 | | 55 | 2.58 | Resin Liquid 3 |
| Carrier 8 | Core Particles 1 | | 55 | 2.58 | Resin Liquid 4 |
| Carrier 9 | Core Particles 6 | | 42 | 2.60 | Resin Liquid 1 |
| Carrier 10 | Core Particles 7 | | 72 | 2.50 | Resin Liquid 1 |
| Carrier 11 | Core Particles 8 | | 61 | 2.22 | Resin Liquid 1 |
| Carrier 12 | Core Particles 9 | | 50 | 2.70 | Resin Liquid 1 |

### Example 1

A developer 1 was prepared by mixing 7 parts of the toner 1 prepared in Toner Production Example 1 and 93 parts of the carrier 1 prepared in Carrier Production Example 1 using a mixer for 3 minutes.

### Examples 2 to 8

Developers 2 to 8 were each prepared in the same manner as in Example 1 except that the carrier 1 was replaced with the carriers 2 to 8, respectively, as presented in Table 2.

### Examples 9 and 10

Developers 9 and 10 were each prepared in the same manner as in Example 1 except that the toner 1 was replaced with the toners 2 and 3, respectively, as presented in Table 2.

### Comparative Example 1

A developer 11 was prepared in the same manner as in Example 1 except that the carrier 1 was replaced with the carrier 9.

### Comparative Examples 2 to 4

Developers 12 to 14 were each prepared in the same manner as in Example 1 except that the carrier 1 was replaced with the carriers 10 to 12, respectively, as presented in Table 2.

For each of the above-prepared developers, the volume average particle diameter of the carrier, the bulk density of the carrier, the type of inorganic particles contained in the resin coating layer of the carrier, the concentration X1 of aluminum in the toner, and the ratio X1/X2 of the concentration X1 of aluminum to the concentration X2 of fluorine are presented in Table 2.

TABLE 2

| | | | | | | | Ratio X1/X2 | |
|---|---|---|---|---|---|---|---|---|
| | | | | Volume | | | of Aluminum | |
| | | | | Average | | Material of | Concentration | |
| | | | | Particle | Bulk | Inorganic | X1 to Fluorine | Aluminum |
| | Developer | | | Diameter | Density | Particles in | Concentration | Concentration |
| | Developer No. | Toner No. | Carrier No. | (μm) | (g/cm³) | Resin | X2 | X1 |
| Example 1 | Developer 1 | Toner 1 | Carrier 1 | 56 | 2.40 | None | 2.7 | 2.1 |
| Example 2 | Developer 2 | Toner 1 | Carrier 2 | 51 | 2.43 | None | 2.7 | 2.1 |
| Example 3 | Developer 3 | Toner 1 | Carrier 3 | 67 | 2.37 | None | 2.7 | 2.1 |
| Example 4 | Developer 4 | Toner 1 | Carrier 4 | 57 | 2.20 | None | 2.7 | 2.1 |
| Example 5 | Developer 5 | Toner 1 | Carrier 5 | 54 | 2.48 | None | 2.7 | 2.1 |
| Example 6 | Developer 6 | Toner 1 | Carrier 6 | 56 | 2.40 | Barium | 2.7 | 2.1 |
| | | | | | | Sulfate | | |
| Example 7 | Developer 7 | Toner 1 | Carrier 7 | 56 | 2.40 | Magnesium | 2.7 | 2.1 |
| | | | | | | Oxide | | |
| Example 8 | Developer 8 | Toner 1 | Carrier 8 | 56 | 2.40 | Hydrotalcite | 2.7 | 2.1 |
| Example 9 | Developer 9 | Toner 2 | Carrier 1 | 56 | 2.40 | None | 5.5 | 3.0 |
| Example 10 | Developer 10 | Toner 3 | Carrier 1 | 60 | 2.40 | None | 3.1 | 3.0 |
| Comparative | Developer 11 | Toner 1 | Carrier 9 | 43 | 2.45 | None | 2.7 | 2.1 |
| Example 1 | | | | | | | | |
| Comparative | Developer 12 | Toner 1 | Carrier 10 | 73 | 2.35 | None | 2.7 | 2.1 |
| Example 2 | | | | | | | | |
| Comparative | Developer 13 | Toner 1 | Carrier 11 | 62 | 2.06 | None | 2.7 | 2.1 |
| Example 3 | | | | | | | | |
| Comparative | Developer 14 | Toner 1 | Carrier 12 | 51 | 2.53 | None | 2.7 | 2.1 |
| Example 4 | | | | | | | | |

### Developer Property Evaluations

Each of the above-prepared developers was put in a commercially-available digital full-color multifunction peripheral (PRO C9100 manufactured by Ricoh Co., Ltd.) to form an image and subjected to the following evaluations: carrier depositions at edge portions and solid portions as evaluations for scraping and resistance fluctuation of carrier during a long-term printing operation; and toner scattering, background fog, image density, and ghost image as evaluations for charging stability during a long-term printing.

### Toner Scattering

After a running test on 1,000,000 sheets, the toner accumulated at a lower part of the developer bearer was sucked and collected, and the mass thereof was measured. The evaluation criteria are as follows.

A (Very good): 0 mg or more and less than 50 mg

B (Good): 50 mg or more and less than 100 mg

C (Acceptable): 100 mg or more and less than 250 mg

D (Poor): 250 mg or more

### Background Fog

One object of the present invention is to provide stable charging performance over an extended period of time from the start of printing by the use of charging performance imparting particles. One method for evaluating this object is to evaluate background fog.

After a running test on 1,000,000 sheets, a process of developing a white blank image was initiated and suspended. During the suspension, toner present on the photoconductor was transferred onto a piece of tape. The piece of tape having the transferred toner thereon and that having no toner thereon were subjected to a measurement of image density using a 938 spectrodensitometer (available from X-Rite Inc.), and the difference in image density (ΔID) therebetween was determined. The evaluation criteria are as follows.

A (Very good): 0 or more and less than 0.005

B (Good): 0.005 or more and less than 0.01

C (Acceptable): 0.01 or more and less than 0.02

D (Poor): 0.02 or more

### Carrier Deposition at Edge Portions

The above machine was placed in an environmental evaluation room (in a low-temperature low-humidity environment of 10 degrees C. and 15% RH) and left for one day, and each of the developers 1 to 14 was put therein to evaluate carrier deposition at edge portions.

Under a specific development condition (with a charging potential (Vd) of −630 V and a development bias DC of −500 V), an image in which solid portions and white-paper portions, each being a 170 μm×170 μm square, were laterally and longitudinally arranged in an alternating manner was output in A3 size. The number of white voids caused due to carrier deposition present at the boundary of the squares was counted. The evaluation criteria are as follows.

A (Very good): 0

B (Good): 1 to 3

C (Acceptable): 4 to 10

D (Poor): 11 or more

### Carrier Deposition at Solid Portions

The above machine was placed in an environmental evaluation room (in an environment of 25 degrees C. and 60% RH) and each of the developers 1 to 14 was put therein to evaluate carrier deposition at solid portions. A process of forming a solid image under a specific development condition (with a charging potential (Vd) of −600 V, a potential of −100 V at the portion corresponding to the image portion (solid portion) after exposure, and a development bias DC of −500 V) was conducted but interrupted by turning off the power supply, to count the number of carrier-deposited portions on the photoconductor after image transfer. Specifically, a 10 mm×100 mm area on the photoconductor was subjected to evaluation. The evaluation criteria are as follows.

A (Very good): 0

B (Good): 1 to 3

C (Acceptable): 4 to 10

D (Poor): 11 or more

### Image Density

The above machine was placed in an environmental evaluation room (in a low-temperature low-humidity environment of 10 degrees C. and 15% RH). After a running test on 100K sheets (100,000 sheets), a white solid image and a black solid image were each printed on three A3-size sheets (RICOH MyPaper). The image density of each solid image was measured using an instrument X-Rite 938 (manufactured by X-Rite Inc.) in a status A mode with d50 light. The evaluation results were ranked as follows.

A (Very good): 1.5 or more

B (Good): 1.4 or more and less than 1.5

C (Acceptable): 1.2 or more and less than 1.4

D (Poor): less than 1.2

### Ghost Image

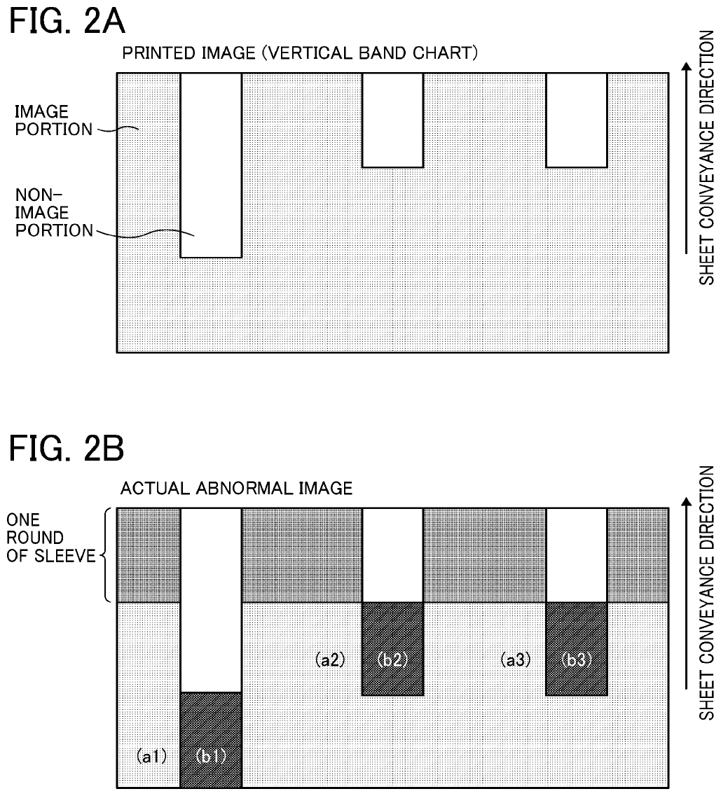

A ghost image was formed by printing an A4-size image chart illustrated in FIG. 2A that is vertical band chart having an image area ratio of 8. The density difference between a portion (a) corresponding to one round of sleeve and another portion (b) corresponding to after one round was measured using an instrument X-Rite 938 (manufactured by X-Rite Inc.) at three measurement positions, i.e., center, rear, and front positions. The average density difference among the three measurement positions was defined as ΔID, and ΔID was ranked as follows.

Ranks A, B, and Care acceptable, and rank D is unacceptable.

A (Very good): 0.01≥ΔID

B (Good) 0.01<ΔID≤0.03

C (Acceptable): 0.03<ΔID≤0.06

D (Unacceptable in practical use): 0.06<ΔID

The results of the image evaluation are presented in Table 3.

TABLE 3

| | | | | | Amount of Carrier | Amount of Carrier | |
|---|---|---|---|---|---|---|---|
| | | | | | Deposition at Edge | Deposition at Solid | |
| | | | | | Portions After | Portions After | |
| | Developer | Toner | Background | Image | Running Test on | Running Test on | Ghost |
| | Name | Scattering | Fog | Density | 1,000,000 Sheets | 1,000,000 Sheets | Image |
| Example 1 | 1 | A | A | A | A | A | A |
| Example 2 | 2 | A | A | A | B | B | A |
| Example 3 | 3 | A | A | B | A | C | C |
| Example 4 | 4 | A | A | B | C | B | B |
| Example 5 | 5 | A | A | C | A | C | A |
| Example 6 | 6 | A | A | B | B | A | A |
| Example 7 | 7 | A | A | B | B | A | A |
| Example 8 | 8 | A | A | C | C | A | A |
| Example 9 | 9 | B | C | A | A | A | A |
| Example 10 | 10 | C | C | B | B | A | A |
| Comparative | 11 | B | C | B | D | C | A |
| Example 1 | | | | | | | |
| Comparative | 12 | A | A | D | C | D | D |
| Example 2 | | | | | | | |
| Comparative | 13 | A | C | B | D | C | C |
| Example 3 | | | | | | | |
| Comparative | 14 | A | B | D | B | D | A |
| Example 4 | | | | | | | |

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. An electrophotographic developer comprising:
a toner containing alumina particles; and
a carrier comprising:
a core particle; and
a resin layer coating a surface of the core particle,
the carrier having a volume average particle diameter (Dv) of from 45 to 70 μm and a bulk density of from 2.1 to 2.5 g/cm³.

2. The electrophotographic developer according to claim 1, wherein the resin layer contains inorganic particles.

3. The electrophotographic developer according to claim 2, wherein the inorganic particles comprise at least one member selected from the group consisting of barium sulfate, zinc oxide, magnesium oxide, magnesium hydroxide, and hydrotalcite.

4. The electrophotographic developer according to claim 1, wherein the alumina particles comprise fluorine-containing alumina.

5. The electrophotographic developer according to claim 4, wherein the following formulae (1) and (2) are satisfied:
2.7≤X1/X2≤5.5 Formula (1)
2.1≤X1≤3.0 Formula (2)
where X1 and X2 represent a concentration of aluminum and a concentration of fluorine in the toner, respectively, determined by X-ray photoelectron spectroscopy (XPS).

6. A replenishment developer comprising the electrophotographic developer according to claim 1,
wherein an amount of the toner is from 2 to 50 parts by mass per 1 part by mass of the carrier.

7. An image forming apparatus comprising:
an electrostatic latent image bearer;
a charger configured to charge the electrostatic latent image bearer;
an irradiator configured to form an electrostatic latent image on the electrostatic latent image bearer;
a developing device containing the electrophotographic developer according to claim 1, configured to develop the electrostatic latent image formed on the electrostatic latent image bearer using the electrophotographic developer to form a toner image;
a transfer device configured to transfer the toner image formed on the electrostatic latent image bearer onto a recording medium; and
a fixing device configured to fix the toner image on the recording medium.

8. A process cartridge comprising:
an electrostatic latent image bearer;
a charger configured to charge a surface of the electrostatic latent image bearer;
a developing device containing the electrophotographic developer according to claim 1, configured to develop an electrostatic latent image formed on the electrostatic latent image bearer using the electrophotographic developer to form a toner image; and
a cleaner configured to clean the electrostatic latent image bearer.

9. An image forming method comprising:
forming an electrostatic latent image on an electrostatic latent image bearer;
developing the electrostatic latent image formed on the electrostatic latent image bearer using the electrophotographic developer according to claim 1 to form a toner image;
transferring the toner image formed on the electrostatic latent image bearer onto a recording medium; and
fixing the toner image on the recording medium.
